(19) United States
(12) Patent Application Publication
(10) Pub. No.: US 2006/0111001 A1
(43) Pub. Date: May 25, 2006

(54) Cellulosic insulation containing a phase change material as an active thermal mass component

(76) Inventors: Jan Kosny, Oak Ridge, TN (US); David W. Yarbrough, Cookeville, TN (US)

Correspondence Address: UT-Battelle, LLC;Office of Intellectual Property, One Bethal Valley Road, 4500N, MS-6258, Oak Ridge, TN, 37831, US

(21) Appl. No.: 10/995,450

(22) Filed: Nov. 23, 2004

(51) Int. Cl. B32B 9/04

(52) U.S. Cl. 442/153

(57) ABSTRACT

A composite thermal insulation material includes a cellulosic fiber matrix component and a phase-change material dispersed in the cellulosic fiber matrix component.

The United States Government has rights in this invention pursuant to contract no. DE-AC05-00OR22725 between the United States Department of Energy and UT-Battelle, LLC.

### FIELD OF THE INVENTION

The present invention relates to stabilized thermal insulation materials, and more particularly to cellulosic thermal insulation materials that contain a phase change material as an active thermal mass component.

### BACKGROUND OF THE INVENTION

Application of thermal mass in buildings can significantly reduce HVAC energy consumption and shift peak hour loads. In residential buildings such savings are estimated to be in the range 5-15% depending of building characteristics and climatic conditions. The thermal efficiency of active thermal mass components is higher for well insulated buildings. Therefore, application of thermal insulation combined with thermal mass component is more efficient than application of insulation alone.

Phase change materials (PCM) have been incorporated as layers in laminated insulation materials. See U.S. Pat. No. 5,770,295 issued to Alderman on Jun. 23, 1998 and entitled “Phase Change Thermal Insulation Structure”, the entire disclosure of which is incorporated herein by reference.

PCM has been microencapsulated into powder form. See U.S. Pat. No. 6,171,647 issued to Holman on Jan. 9, 2001 and entitled “Gel-Coated Microcapsules”, the entire disclosure of which is incorporated herein by reference.

### OBJECTS OF THE INVENTION

Accordingly, objects of the present invention include provision of improved cellulosic insulation, cellulosic insulation having an integral thermal mass component, and an improved method of making cellulosic insulation. Further and other objects of the present invention will become apparent from the description contained herein.

### SUMMARY OF THE INVENTION

In accordance with one aspect of the present invention, the foregoing and other objects are achieved by a composite thermal insulation material that includes a cellulosic fiber matrix component and a phase-change material dispersed in the cellulosic fiber matrix component.

In accordance with another aspect of the present invention, a method of making a composite thermal insulation material includes the steps of: providing a cellulosic fiber matrix component; and dispersing a phase-change material in the cellulosic fiber matrix component to form a composite thermal insulation.

In accordance with a further aspect of the present invention, at least a portion of a thermal barrier includes a composite thermal insulation material including a cellulosic fiber matrix component and a phase-change material dispersed in the cellulosic fiber matrix component.

### BRIEF DESCRIPTION OF THE DRAWINGS

FIG. 1 is a flow diagram showing basic steps of making cellulose insulation.

FIG. 2 is a flow diagram showing basic steps of making cellulose-PCM insulation in accordance with the present invention.

FIG. 3 is a schematic illustration showing a three-layer insulation configuration in accordance with an embodiment of the present invention.

For a better understanding of the present invention, together with other and further objects, advantages and capabilities thereof, reference is made to the following disclosure and appended claims in connection with the above-described drawings.

### DETAILED DESCRIPTION OF THE INVENTION

A simple process is utilized to make a composite insulation material. Cellulosic insulation (cellulose) serves as a matrix phase, and phase-change material (PCM) is dispersed (mixed) therein to make a composite, active thermal mass insulation. Stabilized cellulosic insulation is often in loose-fill form for attic applications, but can be the form of a body of any size or shape, and can be encapsulated into bags, batts, blankets, and other configurations. Stabilized cellulosic insulation also includes spray-applied cellulose insulation and wall-spray cellulose insulation. Cellulosic insulation often comprises products manufactured primarily from recycled or virgin paper materials and can include materials such as, for example, newsprint, cardboard, recycled and/or virgin cotton materials with or without a polymer component, and wood and/or other plant fibers. Some cellulosic insulation is spray-applied and may contain one or more adhesives.

PCM is added in the form of a dry particulate, powder, or emulsion; a form that has been found to be particularly useful is microencapsulated PCM. PCM can be either organic or inorganic. The addition of PCM is accomplished in generally the same manner that chemical fire retardant chemicals are added to cellulose during the manufacturing process. The cellulose-PCM product can be installed in the same manner and using the type of equipment which is currently used by cellulose insulation industry. Installation methods generally include pneumatic, pour-in-place, and spray-applied with dry adhesive or wet adhesive.

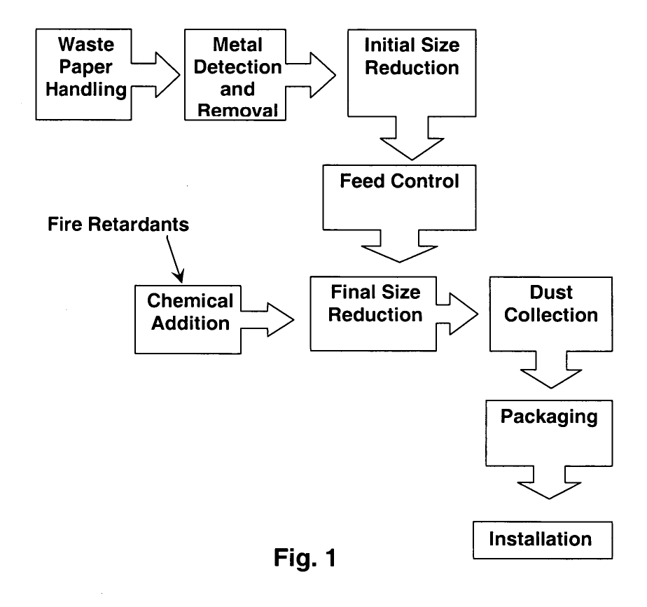

Production of cellulose-PCM insulation in accordance with the present invention can be accomplished using a conventional manufacturing line such as shown FIG. 1, which is a block diagram of basic steps used to manufacture cellulose insulation. All of the steps shown in the arrow boxes in FIG. 1 are well-known and involve conventional equipment and methods. For example, the waste paper processing stages can comprise hammer mills, fiberizers, and/or liquid digesters. The box labeled “Chemical Addition” refers generally to the step of adding, for example, a fire retardant to the cellulosic material.

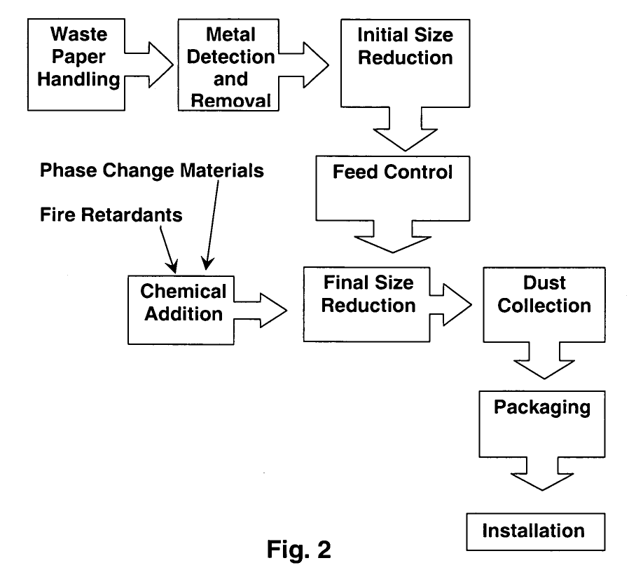

In accordance with the present invention, as shown in FIG. 2, PCM is preferably, but not necessarily, added at the “Chemical Addition” step most conveniently through a separate port. The PCM can be added by weight or by volume to achieve a product with a specific ratio of PCM to cellulose. The PCM is preferably obtained in bulk quantities, preferably in microencapsulated form, but PCM in any form, such as emulsion, powder, for example, can be used. PCM is preferably added in the same manner as are fire retardant chemicals, becoming a dispersed, integral component of the product. The PCM can be added as a discrete component or the PCM can be mixed with fire-retardant or other chemical additives prior to addition to the cellulose. The product, called cellulose-PCM hereinafter, is preferably essentially homogenous, but can be non-homogenous.

Addition of PCM to cellulosic insulation in accordance with the present invention provides an integral thermal mass component in a most efficient and simple manner. Cellulose-PCM insulation made in accordance with the present invention can be used in the same manner as conventional cellulosic insulation in commercial and residential applications, for example below floors, in walls, in roof assemblies, in attics, in shipping containers, on surfaces and various other types of thermal envelopes.

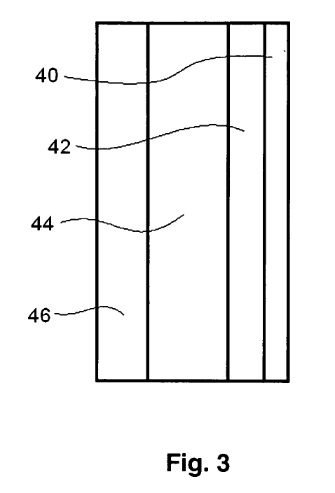

Cellulose-PCM can be used in conjunction with untreated (non-PCM-containing) cellulose in order to achieve selective distribution of PCM in an application. Cellulose-PCM can be installed as a PCM-containing region (volume) in operable association with one or more regions of non-PCM insulation. For example, FIG. 3 shows a three-layer insulation configuration. A first layer of conventional insulation 42 is spray-deposited on a wall 40. A second layer of PCM-cellulose 44 is spray-deposited on the first layer 42. A third layer of conventional insulation 46 is spray-deposited on the second layer 44.

The present invention provides many benefits, including, but not limited to the following:

The present invention combines the features of conventional insulation and an active (re-chargeable) phase-change material.

The present invention requires the same production and field application equipment as conventional cellulose insulation.

The final product of the present invention is unique since it permits the introduction of thermal mass into the building envelope without altering the envelope design.

The present invention can be used as an unsupported spray-applied wall or ceiling insulation.

The present invention can be utilized as active thermal insulation for attics, cathedral ceilings, or below roof decking.

The present invention can be used to insulate floors.

The present invention can be utilized as an insulation/thermal mass component in most building applications where radiant heating and cooling systems are being used.

The present invention can be customized for use in any climate by adjusting the phase-change temperature.

The present invention can significantly reduce energy consumption in residential and commercial buildings due to the potential to shift and reduce peak hour energy loads.

While there has been shown and described what are at present considered the preferred embodiments of the invention, it will be obvious to those skilled in the art that various changes and modifications can be prepared therein without departing from the scope of the inventions defined by the appended claims.

1. A composite thermal insulation material comprising a cellulosic fiber matrix component and a microencapsulated phase-change material essentially homogenously dispersed in said cellulosic fiber matrix component.

2. (canceled)

3. (canceled)

4. (canceled)

5. (canceled)

6. (canceled)

7. A thermal barrier, at least a portion of which comprises a composite thermal insulation material comprising a cellulosic fiber matrix component and a microencapsulated phase-change material essentially homogenously dispersed in said cellulosic fiber matrix component.

8. (canceled)

9. (canceled)

10. A thermal barrier in accordance with claim 7 further comprising at least one region of said composite thermal insulation and at least one other region comprising insulation that is essentially free of PCM.
